(19) United States
(12) Patent Application Publication
(10) Pub. No.: US 2007/0019248 A1
(43) Pub. Date: Jan. 25, 2007

(54) Method for collecting information of business cards in a mobile communication device

(75) Inventors: David Ho, Taipei (TW); Yong-Ping Zheng, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/490,099

(22) Filed: Jul. 21, 2006

(30) Foreign Application Priority Data
Jul. 21, 2005 (TW) 094124665

(51) Int. Cl. H04N 1/40

(52) U.S. Cl. 358/462; 358/448

(57) ABSTRACT

In a method for collecting information of business cards in a mobile communication device including an image capturing unit, a recognition software and a page layout database having a plurality of page layout formats. The image capturing unit captures and converts a traditional business card into an image of a business card, and the recognition software optimizes the image to facilitate recognizing the image. The mobile communication device uses the recognition software and page layout database to analyze and recognize the image of business card according to the page layout database to choose a page layout format from the page layout database that matches the image of business card and, if the page layout format exists, identifies a character from the image of business card, and inputs and stores the character into a business card database in the mobile communication device according to the page layout format, so as to complete the data collection for the traditional business card.

### FIELD OF THE INVENTION

The present invention relates to a method for collecting information of business cards in a mobile communication device, and more particularly to a method that converts traditional business cards into electronic cards, stores the electronic cards in a mobile communication device, and provides a quick and convenient search for information of business cards in the mobile communication device.

### BACKGROUND OF THE INVENTION

As business cards have become a tool for distributing related personal information to others for business purposes, business cards are used extensively for social activities. However, searching for the desired information from hundreds of business cards is time-consuming.

To overcome the foregoing problem, an electronic business card is provided for quickly completing the search of required information of business cards, classifying the business cards and facilitating the use of the business cards. Various different business card machines or electronic business card software are introduced, wherein the business card machine is a specific equipment for printing and producing electronic business cards, and the electronic business card software is a solution for analyzing and collecting the data of a graphic business card by using graphic recognition technology and storing the electronic business cards in a computer database. However, the percentage of the actual use of the aforementioned two solutions is not very high due to the following deficiencies:

(1) Their application is inconvenient because the collection and storage of information of business cards require another hardware or computer to complete the tasks, and thus its practical value generally cannot be accepted by consumers.

(2) Since the printing of different business cards varies, the effect of a business card machine for collecting information automatically is not too good. Furthermore, a scanner is usually used in conjunction with the computer software to complete this task, and the information of business cards so obtained is usually stored in a personal digital assistant (PDA) or a mobile phone to facilitate the portability and use of the information. Therefore, there exists a compatibility issue for the storage format (such as the fields).

As we all know, different industries are blooming and people have high demands on diversified information exchange, and various different existing mobile communication devices such as mobile phones or personal digital assistants (PDA) are used extensively and become an indispensable part of our life. As the mobile communication devices are developed rapidly, mobile communication devices have more functions.

Due to the popularity of mobile communication devices, almost everyone has one or more mobile phones. If personal business cards are digitized, mobile phones will be used as a medium for collecting and managing the business cards. Although these mobile phones can transmit data very conveniently, the short, compact, light and thin design of mobile phones restricts the size of the push buttons on the mobile communication devices, and the mobile phones also come with less buttons, and thus the procedure for inputting data becomes more complicated and inconvenient. Particularly for the input of Chinese characters into a director or a phone book of the mobile communication device, a user has to spend several minutes to enter the personal data of a customer or a friend into the directory or phone book, and such arrangement is inconvenient and troublesome to users.

Therefore, finding a way for completing the digitization of a business card data in a quick and convenient manner to achieve a convenient search for information of business cards anytime or converting a traditional business card into an electronic business card and storing the electronic business card in the mobile communication device demands immediate attentions and feasible solutions.

### SUMMARY OF THE INVENTION

In view of the foregoing shortcomings of the prior art, the inventor of the present invention based on years of experience to conduct extensive researches and experiments and finally invented a method for collecting information of business cards in a mobile communication device.

Therefore, it is a primary objective of the present invention to overcome the foregoing shortcomings by providing a method for collecting information of business cards in a mobile communication device, and the method employs an image capturing unit, a recognition software and a page layout database in the mobile communication device, wherein the mobile communication device uses the image capturing unit to capture an image of a business card of a traditional business card and the recognition software to optimize the image to facilitate recognizing the image. The recognition software performs a page layout analysis and a content recognition for analyzing and recognizing the image of business card according to the page layout database to choose a page layout format from the page layout database that matches the image of business card and, if the page layout format exists, identifying a character from the image of business card, and inputting and storing the character into a business card database in the mobile communication device according to the page layout format, so as to complete the data collection for the traditional business card.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of the structure of a mobile communication device of the present invention;

FIG. 2 is a schematic view of a flow of a mobile communication device collecting business card data according to the present invention;

FIG. 3 is a schematic view of a business card layout of a preferred embodiment of the present invention;

FIG. 4 is a flow chart of performing a page layout analysis according to the present invention;

FIG. 5 is a flow chart of performing a content recognition according to the present invention;

FIG. 6 is a flow chart of performing a debugging process according to the present invention;

FIG. 7A is a schematic view of a directory of a preferred embodiment of the present invention;

FIG. 7B is a schematic view of a next step of a directory of a preferred embodiment of the present invention; and

FIG. 7C is a schematic view of a next step of a directory of a preferred embodiment of the present invention.

### DETAILED DESCRIPTION OF THE PREFERRED EMBODIMENTS

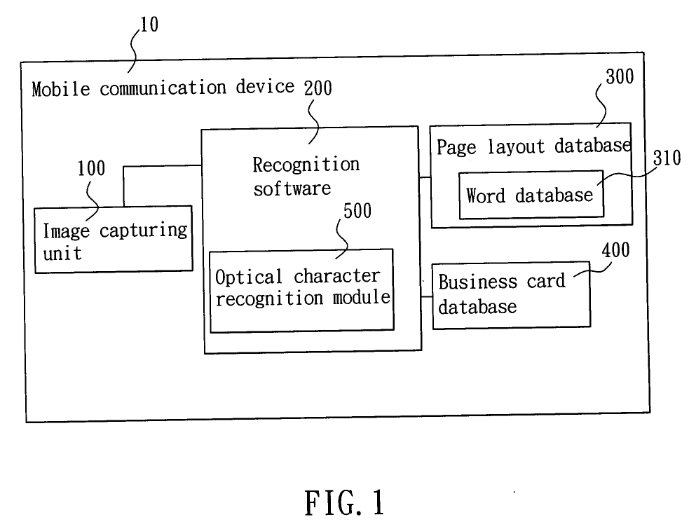

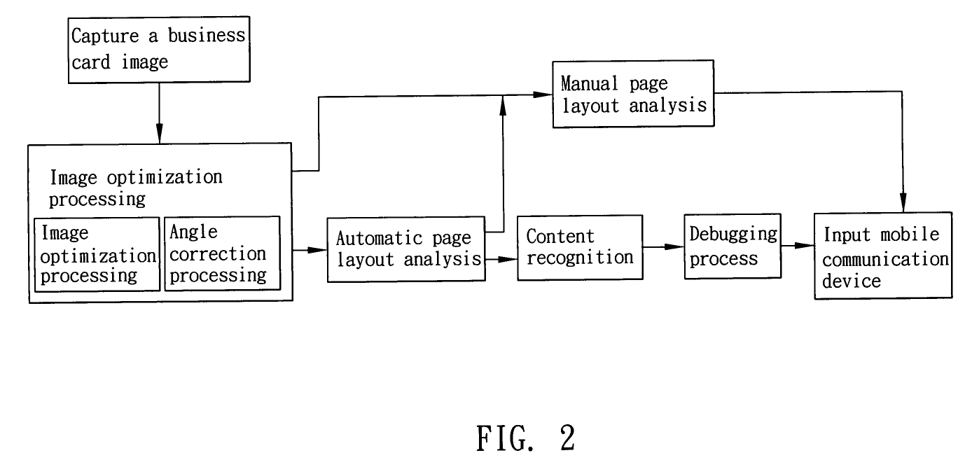

Referring to FIGS. 1 and 2 for the method for collecting information of business cards in a mobile communication device in accordance with the present invention, the method installs an image capturing unit 100 on a mobile communication device 10, a recognition software 200 and a page layout database 300 having a plurality of page layout formats, wherein the mobile communication device 10 uses the image capturing unit 100 to capture a traditional business card into an image of a business card and then uses the recognition software 200 to perform an image optimization procedure for optimizing the image of business card, and the image optimization procedure facilitates the recognition software 200 to carry out the recognition operation. The mobile communication device 10 uses the recognition software 200 and page layout database 300 to analyze and recognize the image of business card. After a page layout format which is matched with the image of business card is chosen, the required characters are obtained from the page layout format of the image of business card according to each page layout format and inputted or stored into a business card database in the mobile communication device 10 as a directory of the mobile communication device 10, so as to complete the data collection of the traditional business card without the need of using any other input element of the mobile communication device 10 to input the data of traditional business cards into the mobile communication device 10 one by one and facilitate the mobile communication device 10 to use the business card database for other processing such as dialing a call or displaying an incoming call later.

When the image capturing unit 100 captures the image of business card, external environments such as dust or paper quality may cause misjudgments of the recognition software 200 or the data of the business card cannot be recognized correctly. When a business card is captured, the business card may be titled instead of being placed properly, and thus it may cause problems to the data processing. Referring to FIG. 2 for a preferred embodiment of the present invention, the image optimization procedure includes an image gray scale processing and an angle adjusting processing, and the image gray scale processing gray scales the image of the business card for reducing interferences with the quality of said image of the business card, and the angle adjusting processing solves the problem of a tilted business card that is not placed properly by aligning the image of the business card, according to four corner edges or a typesetting of the business card, to counteract ill effect of tilting of the business card, so that the page layout analysis and content recognition executed by the recognition software 200 can be carried out successfully.

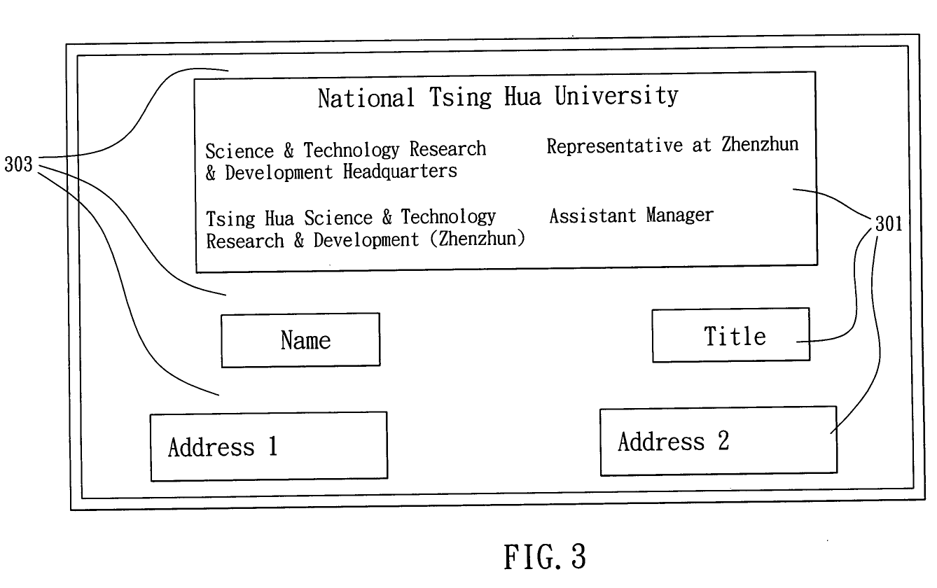

Referring to FIG. 3, the page layout format also includes a plurality of blocks 301; for example, the page layout of the business card can be generally divided into a department block, a name block, a title block and a telephone address block, and any one of the page layout formats is arranged in a different configuration of types of blocks 301 since most information are concentrated at a limited area of the traditional business card, and these information are usually situated at a specific area 301, and manufacturers can analyze and generalize the type of data and page layout of the traditional business card and input the results into a page layout database 300 (as shown in FIG. 1), and a space 303 is disposed between these blocks 301 for separating the blocks 301. In the meantime, most of the positions of these classified blocks 301 have specific patterns, such as the name block is usually arranged adjacent to the title block, and most of the telephone address blocks are arranged at the bottom of the business card or most of the department blocks are placed at the top or the central position of the business card.

In this embodiment, the page layout database 300 (as shown in FIG. 1) stores a large quantity of data and different page layouts of the analyzed and collected traditional business cards in advance and generalizes the data and page layouts into a page layout format, and the types of page layouts of the traditional business cards are listed in the following table.

| Serial | | |
|---|---|---|
| No. | Page Layout Format | Description |
| A | Department | Department, name and title, and |
| | Name and Title | address are arranged from top to |
| | Address 1 Address 2 | bottom, and there are two |
| | | address blocks. |
| B | Department | It is basically the same as A, except |
| | Name and Title | there is only one address block. |
| | Address | |
| C | Name and Title | Name and title are listed at the top, |
| | Department | and there is only one address block. |
| | Address | |
| D | Name and Title | It is similar to C, but there is one |
| | Department | more address block. |
| | Address 1 Address 2 | |
| E | Department | Department block is listed at the top, |
| | Name and Title address | and name and title block |
| | | is arranged next to address. |
| F | Name and Title | Name and title are listed at the top, |
| | Department Address | and department and address |
| | | are listed at the bottom. |
| G | Other | This type includes the |
| | | following features: |
| | | 1. It is very personal, and thus has its |
| | | own type. |
| | | 2. The page layout is very |
| | | complicated and cannot be classified. |
| | | 3. The blocks are arranged arbitrarily |
| | | in landscape and portrait layouts. |

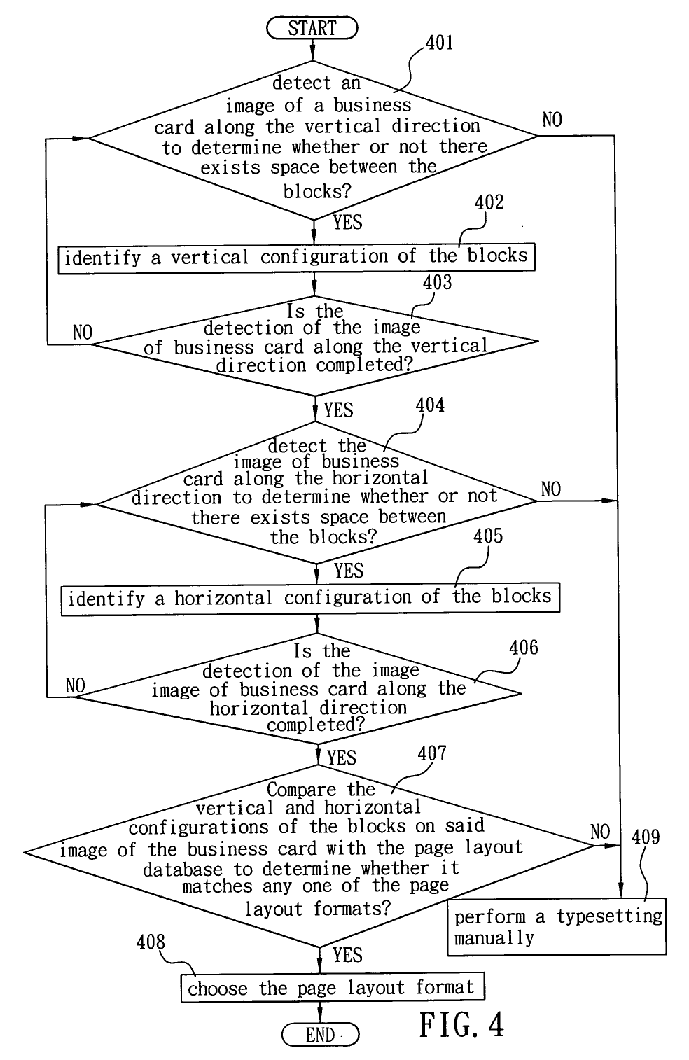

Referring to FIGS. 1, 2 and 3, the recognition software 200 starts performing a page layout analysis for an image of the business card, after the image capturing unit 100 captures the image of the business card, wherein the recognition software 200 is divided into a manual page layout analysis and an automatic page layout analysis, such that after the manual page layout analysis is executed, the type of the blocks 301 can be selected by users to adjust the size of the blocks 301. As to the automatic page layout analysis, the recognition software 200 identifies the configuration of each block 301 by using the space 303 between the blocks 301 for the determination, and the flow chart for determining the configuration of each block 301 as shown in FIG. 4 comprises the following steps:

(Step 401) This step detects an image of a business card along the vertical direction to determine whether or not there exists space 303 between the blocks 301 in a vertical direction; if yes, then processes Step 402, or else processes Step 409.

(Step 402) This step identifies a vertical configuration of the blocks 301 on the image of business card.

(Step 403) This step determines whether or not the detection of the image of business card along the vertical direction is completed; if yes, then processes Step 404, or else returns to Step 401.

(Step 404) This step detects the image of business card along the horizontal direction to determine whether or not there exists space 303 between the blocks 301 in a horizontal direction; if yes, then processes Step 405, or else processes Step 409.

(Step 405) This step identifies a horizontal configuration of the blocks 301 on the image of business card.

(Step 406) This step determines whether nor not the detection of the image of business card along the horizontal direction is completed; if yes, then processes Step 407, or else returns to Step 404.

(Step 407) This step compares the vertical and horizontal configurations of the blocks 301 on said image of the business card with the page layout database 300 to determine whether it matches any one of the page layout formats; if yes, then processes Step 408, or else processes Step 409.

(Step 408) This step chooses the page layout format and exits the procedure.

(Step 409) This step performs a typesetting manually.

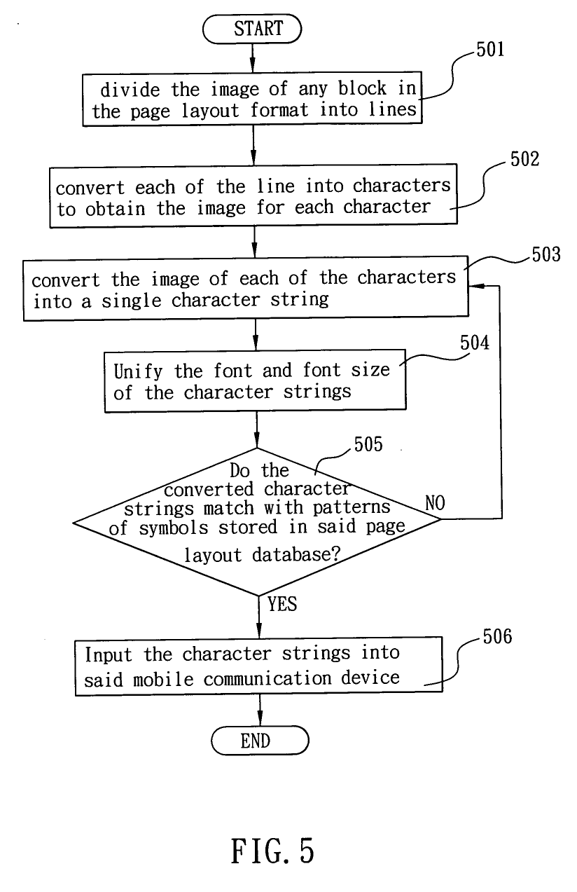

After performing a page layout analysis for the image of business card, the recognition software 200 will perform a content recognition for the chosen page layout format. In a preferred embodiment of the present invention as shown in FIG. 1, the recognition software 200 includes an optical character recognition module 500 for recognizing each of characters (including a word, a number, or a punctuation mark) in the image of business card, and converting the characters into at least one character string according to the permutation of the characters, and the recognition software 200 will not perform a recognition for the patterns in the image of business card, and the business card data is the portion of the recognized characters in the image of business card, and this portion includes data such as a company name, a name, a telephone number, an extension number, a fax number, a title and an E-mail address of the business card. The procedure of the content recognition as shown in FIG. 5 comprises the following steps:

(Step 501) The recognition software 200 divides the image of any block in the page layout format into lines.

(Step 502) The recognition software 200 converts each of the line into characters, so as to obtain the image for each character.

(Step 503) This step uses the optical character recognition module 500 to convert the image of each of the characters into a single character string.

(Step 504) The recognition software 200 unifies the font and font size of the character strings to enhance the efficiency of the recognition carried out later.

(Step 505) The recognition software 200 compares the converted character strings with patterns of symbols stored in the page layout database 300 by using a debugging process (as shown in FIG. 2) to determine whether or not the character strings match with patterns of symbols stored in said page layout database 300 corresponding to the blocks of the chosen page layout format; if yes, then processes Step 506, or else returns to Step 503.

(Step 506) This step inputs the character strings into said mobile communication device if the character strings match with the patterns of symbols stored in the page layout database 300.

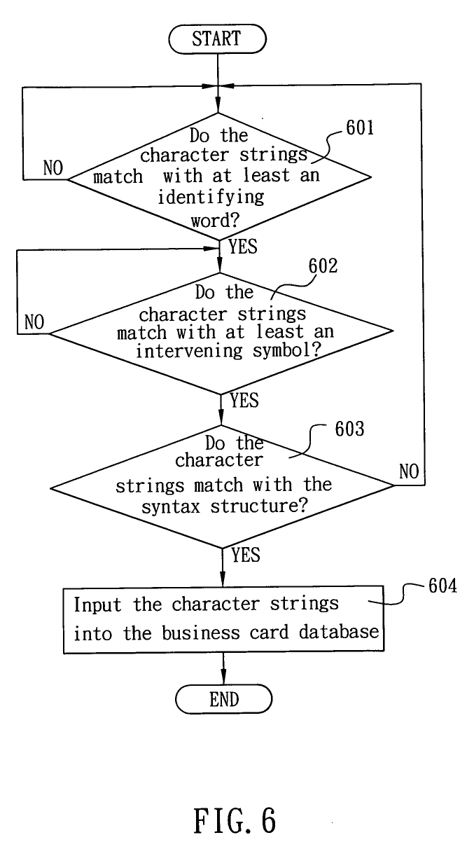

In this embodiment, the patterns of symbols 310 has built in a plurality of identifying words (such as the identifying word “TEL” and “TELEPHONE” which is related to the telephone block) related to each block 301, a plurality of intervening symbols (such as a semicolon “:”, a comma “,” or an at symbol “@”) and a syntax structure (such as <Identifying Word>+<Intervening symbol>+<Content>), and the debugging process uses the identifying words and intervening symbols to recognize the data in each block 301, and after the recognition software 200 obtains the character strings of the block 301, the debugging process carries out the following steps as shown in FIG. 6:

(Step 601) The recognition software 200 compares the character strings with the identifying word related to each block 301 to determine whether or not the character strings match with at least an identifying word; if yes, then processes Step 602, or else returns to Step 601.

(Step 602) The recognition software 200 compares the converted character strings with the intervening symbols matched with the corresponding block 301 to determine whether or not the character strings match with at least an intervening symbol; if yes, then processes Step 603, or else returns to Step 602.

(Step 603) The recognition software 200 compares the converted character strings with the syntax structure matched with the corresponding block to determine whether or not the character strings match with the syntax structure, if yes, then processes Step 604, or else returns to Step 601.

(Step 604) This step inputs the character strings into the business card database 400 (as shown in FIG. 2) that is stored in the mobile communication device 10.

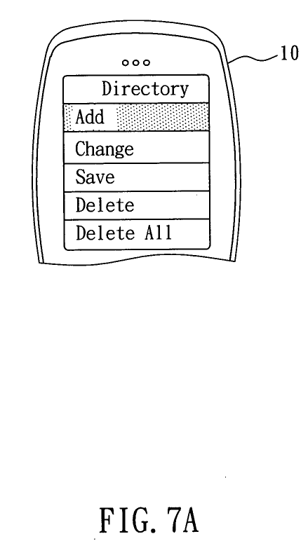

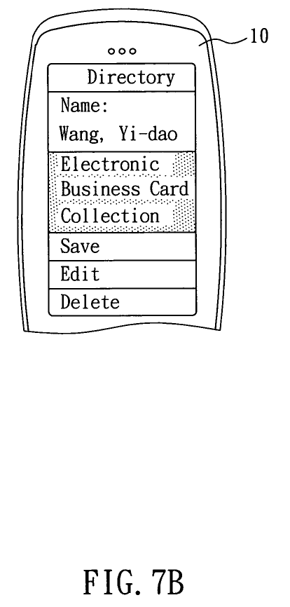

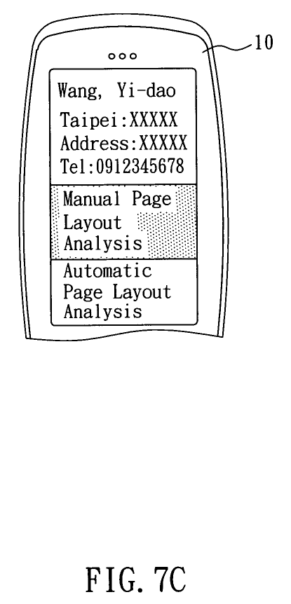

In a preferred embodiment of the present invention as shown in FIG. 1, the mobile communication device 10 is a mobile phone, and the image capturing unit 100 of the mobile communication device 10 is a digital camera having a high-resolution (such as a mega pixel) shooting mode, and its photographic quality is almost the same as the quality of a professional camera. In the meantime, the lens of the image capturing unit 100 should be large enough to capture the whole image of business card, and thus a high resolution and a large lens of the digital camera are needed for the recognition software 200 to perform the page layout analysis and content recognition. Further, the business card database 400 is a directory as shown in FIG. 7A, and the function of adding a record into the directory can be selected as shown in FIG. 7B, and the menu of the directory includes an option for collecting an electronic business card, such that after the mobile phone aims at a paper business card and the digital camera is turned on to capture an image of a business card, the option for collecting the electronic business card is selected to execute the recognition software as shown in FIG. 7C, and the options of the manual page layout analysis and automatic page layout analysis appear on the mobile phone, such that after one of the options of the manual page layout analysis and automatic page layout analysis is selected, the recognition and input procedures that follow can be performed.

In view of the description above, the method for the mobile communication device 10 to collect business card data by using a digital camera and an image recognition technology according to the present invention has the following advantages:

1. The business card data is connected solely by the mobile communication device 10 having an image capturing unit 100 without the need of installing other additional hardware, and thus it can thoroughly solve the problem of the business card machine that requires a computer for the editing and management tasks.

2. The automatic recognition design of the invention can directly store the business card data into the mobile communication device 10, and thus it can solve the problem of the mobile communication device 10 that requires users to enter the business card data one by one, causes tremendous inconvenience, and lowers the efficiency.

3. The invention provides an automatic page layout analysis as well as a manual page layout analysis for users, so as to enhance the accuracy of the data collection and provide a flexible quick data collection for incompatible page layouts.

While the invention herein disclosed has been described by means of specific embodiments, numerous modifications and variations could be made thereto by those skilled in the art without departing from the scope and spirit of the invention set forth in the claims.

What is claimed is:

1. A method for collecting information of business cards in a mobile communication device including an image capturing unit, a recognition software and a page layout database having a plurality of page layout formats, said method comprising the steps of:
said image capturing unit capturing an image of a business card;
optimizing the image, by using the recognition software, to facilitate recognizing the image;
analyzing and recognizing, by utilizing said recognition software and said page layout database, said image of the business card to choose a page layout format that matches said image of the business card; and
if the page layout format exists, identifying a character from said image of the business card, and inputting and storing the character into a business card database in said mobile communication device according to said page layout format.

2. The method of claim 1, wherein optimizing the image comprises:
gray-scaling said image of the business card to reduce interference with the quality of said image of the business card; and
an angle adjusting process aligning said image of the business card, according to four corner edges or a typesetting of said business card, to counteract ill effect of tilting of the business card.

3. The method of claim 1, wherein each of said page layout formats is arranged in a different configuration of types of blocks.

4. The method of claim 3, wherein said recognition software includes a manual page layout analysis for selecting said types of blocks and adjusting size of the blocks by a user.

5. The method of claim 4, wherein said recognition software includes an automatic page layout analysis for identifying the configuration of the blocks according to space between the blocks, comprising the steps of:
determining whether or not there exists space between the blocks in a vertical direction by detecting said image of the business card along the vertical direction;
identifying a vertical configuration of the blocks on said image of the business card, if there exists space between the blocks in the vertical direction;
determining whether or not there exists space between the blocks in a horizontal direction by detecting said image of the business card along the horizontal direction;
identifying a horizontal configuration of the blocks on said image of the business card if there exists space between the blocks in the horizontal direction;
choosing the page layout format, matching said vertical and horizontal configurations of the blocks on said image of the business card.

6. The method of claim 5, wherein if no space between the blocks in the vertical direction exists a manual typesetting method is performed.

7. The method of claim 5, wherein if no space between the blocks in the horizontal direction exists a manual typesetting method is performed.

8. The method of claim 5, wherein if the page layout format does not exist, a manual typesetting method is performed.

9. The method of claim 3, wherein said recognition software includes an optical character recognition module for recognizing each of characters in said image of the business card and converting said characters into at least one character string according to permutation of said characters and said character recognition module does not recognize patterns in said image of the business card, and the procedure for recognizing and converting characters in said image of the business card comprises the steps of:
dividing said image into a plurality of lines by using said recognition software;
converting each of the lines into characters, by using said recognition software, for obtaining images of said characters;
converting the image of each of said characters into a single character string by using said optical character recognition module;
said recognition software unifying the font of said character strings to enhance efficiency of subsequent recognition;
said recognition software determining whether or not said character strings match patterns of symbols stored in said page layout database corresponding to the blocks of the chosen page layout format; and
inputting said character strings into said mobile communication device if said character strings match the patterns of symbols stored in said page layout database.

10. The method of claim 9, wherein each of said patterns of symbols has at least an identifying word, at least an intervening symbol and a syntax structure related to one of the blocks of the chosen page layout format, and in determining whether or not said character strings match said each pattern of symbols, said recognition software proceeds the steps of:
said recognition software determining whether or not said character strings match said at least an identifying word;
if said character strings match said at least an identifying word, said recognition software determining whether or not said character strings match said at least an intervening symbol;
if said character strings match said at least an intervening symbol, said recognition software determining whether or not said character strings match the syntax structure; and
if said character strings match said syntax structure, inputting said character strings into the business card database stored in said mobile communication device.

11. The method of claim 10, wherein said business card database is a directory.
